(19) United States
(12) Patent Application Publication
(10) Pub. No.: US 2019/0210394 A1
(43) Pub. Date: Jul. 11, 2019

(54) READING STAFF BOOK SYSTEM

(71) Applicant: Beatrice A. Darby, Vineland, NJ (US)

(72) Inventor: Beatrice A. Darby, Vineland, NJ (US)

(21) Appl. No.: 16/200,783

(22) Filed: Nov. 27, 2018

Related U.S. Application Data
(60) Provisional application No. 62/613,824, filed on Jan. 5, 2018.

(51) Int. Cl. B42D 9/00

(52) U.S. Cl. CPC B42D 9/00

(57) ABSTRACT

A reading staff book system provides the book reader with a simple and efficient way of holding a book and maintaining it during the reading process. The system includes a “reading staff” which is rigidly secured to and extends down from a back cover of a book. The reading staff is then held by the reader, thereby permitting unimpeded access to all pages of the book. Each page can be turned without the need to physically grasp the book, providing the reader with a free hand and, importantly, allowing for an easier and more enjoyable reading experience.

### RELATED APPLICATION

This application claims the benefit of application Ser. No. 62/613,824, filed on Jan. 5, 2018.

### FIELD OF THE INVENTION

The present invention relates to the field of reading and literacy assistance.

### BACKGROUND OF THE INVENTION

Despite the advent and popularity of books downloaded onto electronic devices, many people still prefer the feel and satisfaction of reading while physically holding a printed book. This usually entails grasping the book with both hands, often times requiring that the reader's fingers cover outlying words or pictures on the page.

### SUMMARY OF THE INVENTION

Thus, the object of the present invention overcomes the minor, yet sometimes annoying and disrupting disadvantages of physically holding a book while reading.

The Reading Staff Book System of the present invention provides the reader of a book or like reading material with a simple, efficient and unimpeded way of holding that book and maintaining it during the reading process.

Towards this end, the invention comprises a “reading staff” which is rigidly secured to and extends down from a back cover of a book. The reading staff is then held by the reader, thereby permitting unimpeded access to all pages of the book. Each page can be turned without the need to physically grasp the book, providing the reader with a free hand and, importantly, allowing for an easier and more enjoyable reading experience.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE FIGURES

FIG. 1 is a front view of the Reading Staff Book System of the present invention, with the book component of the system closed.

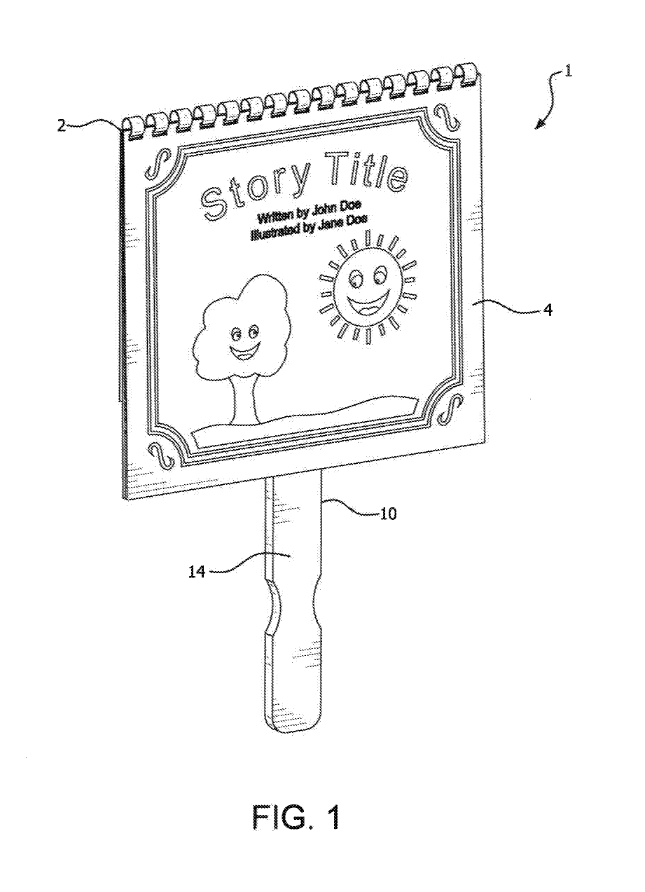

FIG. 2 is a rear view of the Reading Staff Book System of the present invention showing one means of attachment of the “reading staff” to a back cover of the book component.

FIG. 3 is a view of the Reading Staff Book System of the present invention in use, illustrating the turning of a page.

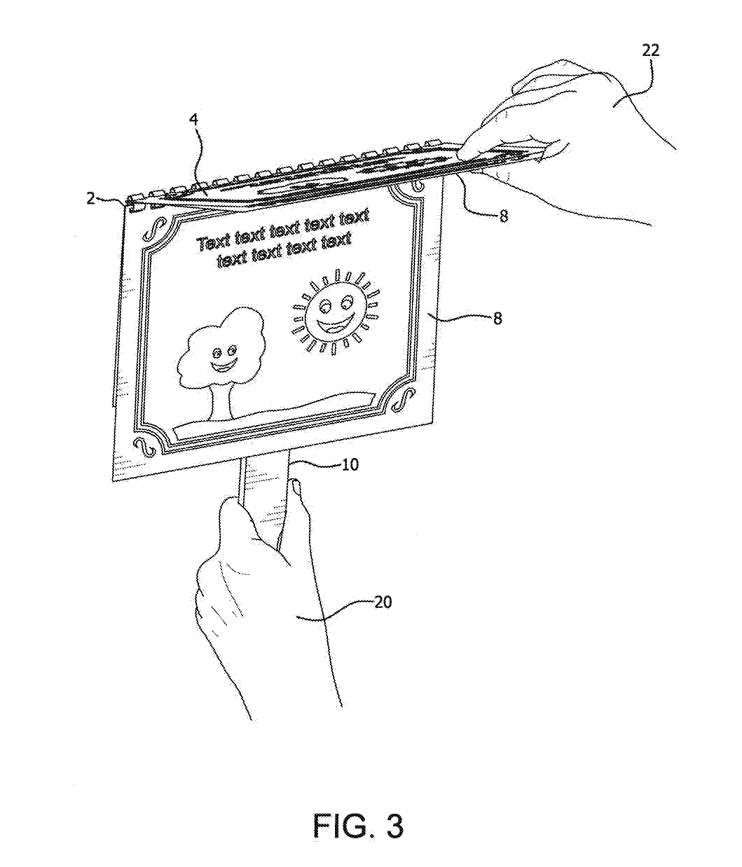

### DETAILED DESCRIPTION OF THE INVENTION

The Reading Staff Book System it of the present invention comprises book component 2 with front cover 4, back cover 6 and a plurality of pages 8. Elongated reading staff 10 has upper section 12 and lower handle section 14.

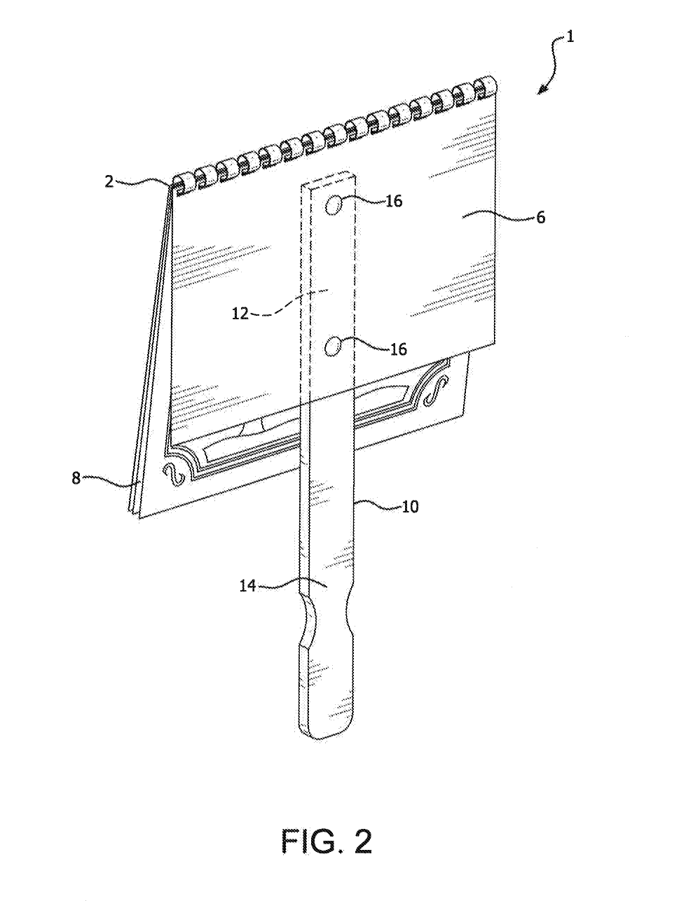

Upper section 12 of reading staff 10 is secured to back cover 6 of book component 2 by attachment means, which could be rivets 16, as seen in FIG. 2, or staples, tacks, screws, or other equivalent attachment means.

It is contemplated that reading staff 10 could take the form of any equivalent elongated member, such as a stick, a rod, a bar, a shaft, and the invention should not be considered restricted to the particular staff member disclosed herein.

When secured to back cover 6, lower handle section 14 of reading staff 10 extends down, below book component 2, where it can easily be held in one hand 20 by the reader. This allows the reader a free hand 22, which can easily turn pages 8, and affords the reader with an unimpeded view of the pages.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A reading staff book system comprising:
a book component having a front cover, a back cover, and a plurality of pages between the front and back covers;
an elongated staff member having an upper section and a lower handle section; and
staff member attachment means for securing the upper section of the staff member to the back cover of the book component, whereby when the upper section is secured to the back cover, the lower handle section of the staff member extends below the book component and is configured to be held by a reader of said book component.

2. The reading staff book system as in claim 1 wherein the attachment means comprises rivets.
